(19) United States
(12) Patent Application Publication
(10) Pub. No.: US 2006/0232779 A1
(43) Pub. Date: Oct. 19, 2006

(54) Apparatus and method based on cavity ring-down spectroscopy

(76) Inventor: Andrew Mark Shaw, Kenn (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/543,568

(22) PCT Filed: Jan. 8, 2004
(86) PCT No.: PCT/GB04/00020

§ 371 Date: Apr. 25, 2006

(30) Foreign Application Priority Data
Jan. 30, 2003 (GB) 0302174.8

(51) Int. Cl. G01N 21/59

(52) U.S. Cl. 356/436

(57) ABSTRACT

This invention is generally concerned with sensing apparatus and methods, more particularly apparatus and methods for sensing techniques based upon cavity ring-down spectroscopy (CRDS). An evanescent wave cavity-based optical sensor is described. The sensor comprises an optical cavity formed by a pair of highly reflective surfaces (108, 110) such that light within said cavity makes a plurality of passes between said surfaces, an optical path between said surfaces including a reflection from a totally internally reflecting (112) surface, said reflection from said reflection from said surface generating an evanescent wave to providing a sensing function; a light source (102) to inject light into said cavity; and a detector (114) to detect a light level within said cavity; whereby absorption of said evanescent wave is detectable using said detector to provide said sensing function; wherein said light source comprises a continuous wave light source; and wherein said light source has a power and bandwidth sufficient to couple energy into at least two modes of oscillation of said cavity to overcome losses within the cavity and excite at least two modes of oscillation of said cavity.

This invention is generally concerned with sensing apparatus and methods, more particularly apparatus and methods for sensing techniques based upon cavity ring-down spectroscopy (CRDS).

Cavity Ring-Down Spectroscopy is known as a high sensitivity technique for analysis of molecules in the gas phase (see, for example, G. Berden, R. Peeters and G. Meijer, Int. Rev. Phys. Chem., 19, (2000) 565, P. Zalicki and R. N. Zare, J Chem. Phys. 102 (1995) 2708, M. D. Levinson, B. A. Paldus, T. G. Spence, C. C. Harb, J. S. Harris and R. N. Zare, Chem. Phys. Lett. 290 (1998) 335, B. A. Paldus, C. C. Harb, T. G. Spence, B. Willde, J. Xie, J. S. Harris and R. N. Zare, J. App. Phys. 83 (1998) 3991. D. Romanini, A. A. Kachanov and F. Stoeckel, Chem. Phys. Lett. 270 (1997) 538). The CRDS technique can readily detect a change in molecular absorption coefficient of 10⁻⁶cm⁻¹ , with the additional advantage of not requiring calibration of the sensor at the point of measurement since the technique is able to determine an absolute molecular concentration based upon known molecular absorbance at the wavelength or wavelengths of interest Although the acronym CRDS makes reference to spectroscopy in many cases measurements are made at a single wavelength rather than over a range of wavelengths.

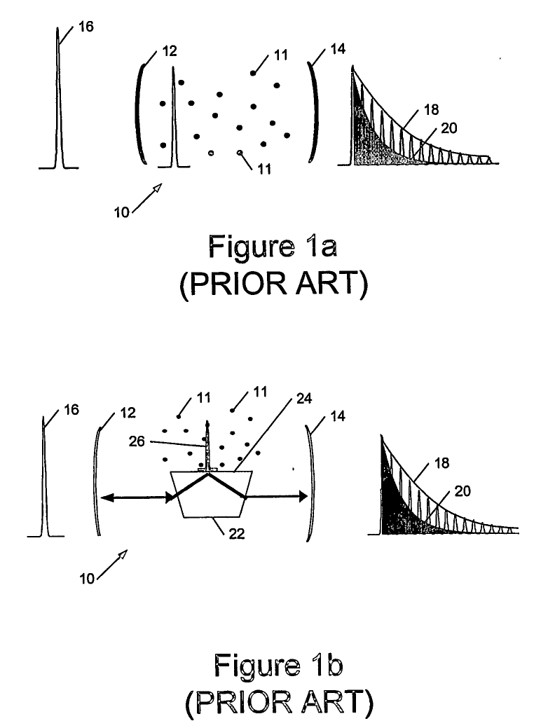

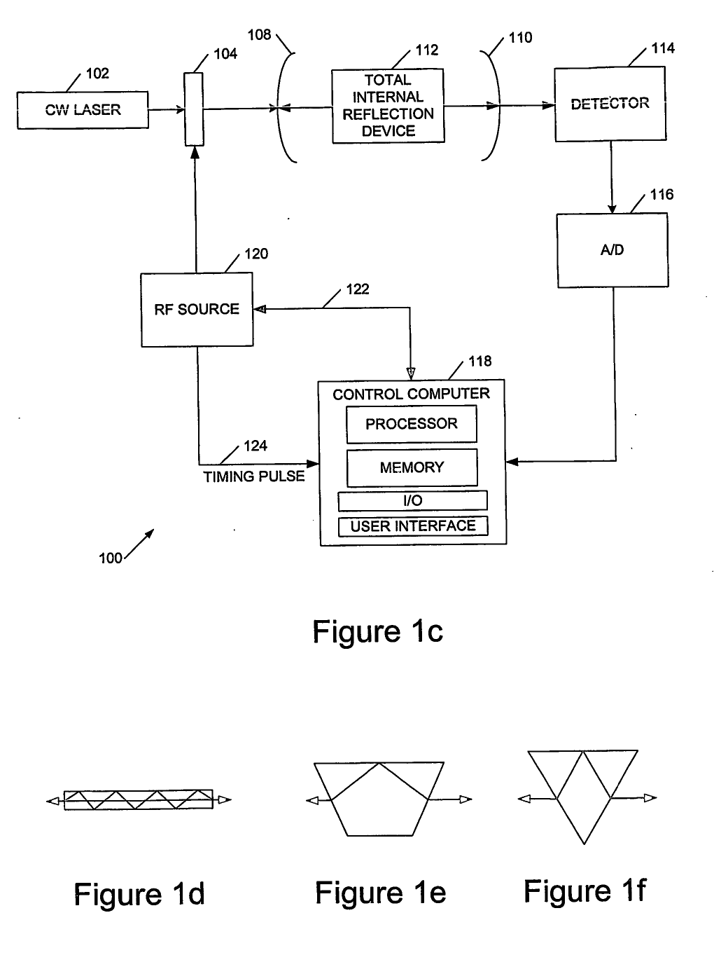

FIG. 1a, which shows a cavity 10 of a CRDS device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, τ. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time τ is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, Δτ, is a function of the strength of absorption of the molecule at the frequency, v, of interest α(v) (the molecular extinction coefficient) and of the concentration per unit length, lₛ, of the absorbing species and is given by equation 1 below.
Δτ=tᵣ/{2(1−R)+α(v)lₛ} (Equation 1)
where R is the reflectivity of each of mirrors 12, 14 and tᵣ is the round trip time of the cavity, tᵣ=c/2L where c is the speed of light and L is the length of the cavity. Since the molecular absorption coefficient is a property of the target molecule, once Δτ has been measured the concentration of molecules within the cavity can be determined without the need for calibration.

It will be appreciated that to employ equation 1 measurements of the mirror reflectivities, the molecular absorption (or extinction) coefficient, the cavity length and (where different) the sample lengths are necessary but these may be determined in advance of any particular measurement, for example, during initial set up of a CRDS machine. Likewise since the decay times are generally relatively short, of the order of tens of nanoseconds, a timing calibration may also be needed, although again this may be performed when the apparatus is initially set up.

It will be further appreciated that to achieve a high sensitivity the reflectivities of mirrors 12, 14 should be high (whilst still permitting a detectable level of light to leak out) and typically R equals 0.9999 to provide of the order of 10⁴ bounces. If the total losses in the cavity are around 1% there will only be 3 or 4 bounces and consequently the sensitivity of the apparatus is very much reduced; in practical terms it is desirable to have total losses less than 0.25%, corresponding to around 200 bounces during decay time τ, or approximately 1000 bounces during ring down of the entire cavity.

One problem with CRDS is that the technique is only suitable for sensing molecules which are introduced into the cavity in a gas since if a liquid or solid is introduced into the cavity losses become very large and the technique fails. A known solution to this problem employs so-called evanescent waves CRDS (e-CRDS) as described in U.S. Pat. No. 5,943,136, U.S. Pat. No. 5,835,231 and U.S. Pat. No. 5,986,768. It is believed that work on e-CRDS is also being performed by Professor Zare at Stamford University, California, and basic CRDS work is, it is believed, being performed by Informed Diagnostics, Tiger Optics, and Los Gatos Research, all in the USA.

FIG. 1b, in which like elements to those of FIG. 1a are indicated by like reference numerals, shows the idea underlying e-CRDS. In FIG. 1b a prism 22 (as shown, a pellin broca prism) is introduced into the cavity such that total internal reflection (TIR) occurs at surface 24 of the prism Total internal reflection will be familiar to the skilled person, and occurs when the angle of incidence (to a normal surface) is greater than a critical angle θ_{c} where sin θ_{c} is equal to n₂/n₁ where n₂ is the refracted index of the medium outside the prism and n₁ is the refractive index of the material of which the prism is composed. Beyond this critical angle light is reflected from the interface with substantially 100% efficiency back into the medium of the prism, but a non-propagating wave, called an evanescent wave (e-wave) is formed beyond the interface at which the TIR occurs. This e-wave penetrates into the medium above the prism but it's intensity decreases exponentially with distance from the surface, typically over a distance of the order of the a wavelength. The depth at which the intensity of the e-wave falls to 1/e (where e=2.718) of it's initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules in a gaseous phase. In the configuration of FIG. 1b molecules near the total internal reflection surface 24 are effectively in optical contact with the cavity, and are sampled by the e-wave resulting from the total internal reflection at the surface.

Although the sensitivity of e-CRDS apparatus is very high it is nonetheless desirable to provide further improvements in the sensitivity of sensors based upon this general principle. The sensitivity of an e-CRDS or a conventional CRDS-based device may be improved by taking a succession of measurements and averaging the results. However the frequency at which such a succession of measurements can be made is limited by the maximum pulse rate of the pulsed laser employed for injecting light into the cavity. This limitation can be addressed by employing a continuous wave (cw) laser such as a laser diode, since such lasers can be switched on and off faster than a pulsed laser's maximum pulse repetition rate. However, there are significant difficulties associated with coupling light from a cw laser into the cavity, particularly where a so-called stable cavity is employed, typically comprising planar or concave mirrors.

With pulsed laser radiation the pulse is generally short enough that the length, in distance, of the pulse is less than the cavity length so that the pulse does not interfere with itself, however, standing wave patterns are created when cw laser radiation is employed One effect of these standing waves is to create a set of longitudinal (and transverse) cavity modes, with the result that light may only be coupled into the cavity when it has precisely the right frequency. The line width of a laser diode is usually very small and therefore does not overlap more than one longitudinal mode of the ring-down cavity and thus to couple the laser light into the cavity requires the frequency of a cavity mode to be matched to the laser frequency (or vice versa). This is explained further below. The result is that the output frequency or frequencies of the exciting laser, generally determined by the laser cavity length, must match allowed frequencies of the (e-)CRDS cavity. The cavities of both the laser and of the cavity ring-down device will also change in length with temperature, thus further complicating coupling of these two systems. An additional difficulty arises because of the need to keep losses within the cavity to a minimum, thus making it difficult to incorporate a mode sensor within the ring-down cavity.

Despite these difficulties cw lasers have been used with CRDS sensors (see G. Berden, R. Peeters and G. Meijer, Int. Rev. Phys. Chem., 19, (2000) 565, P. Zalicki and R. N. Zare, J. Chem. Phys. 102 (1995) 2708). This has been done by, broadly speaking, dithering the lengths of the ring-down cavity in an attempt to locate a resonant position, electronic feedback then being using to lock the cavity length. Such electronic feedback is particularly difficult to apply in a device based upon the e-CRDS principle in which the optical path in the cavity includes an ATIR device.

According to a first aspect of the present invention there is therefore provided [as claim 1].

Employing a continuous wave light source, preferably a continuous wave laser, with sufficient power and bandwidth to overlap and excite at least two modes of the ring-down cavity facilitates coupling of light from the light source into the cavity even when modes of the light source and cavity are not exactly aligned. Preferably the sensor is an evanescent wave cavity ring-down sensor including an attenuated total internal reflection-based (ATIR) sensing device since when used for sensing a substance in the liquid or solid phase the width of an absorption band of the sensed substance is generally larger than of a gas-phase absorption, thus further facilitating coupling of light into the ring-down cavity without the need for exact tuning of the light source.

Thus in another aspect the invention provides [as claim 3].

The evanescent wave may either sense a substance directly or may mediate a sensing interaction through sensing a substance or a property of a material. The detector detects a change in light level in the cavity resulting from absorption of the evanescent wave, and whilst in practice this is almost always performed by measuring a ring-down characteristic of the cavity, in principle a ring-up characteristic of a cavity could additionally or alternatively be monitored. As the skilled person will appreciate the reflecting surfaces of the sensor are optical surfaces generally characterized by a change in reflective index, and may physically comprise internal or external surfaces.

The light source may comprise a shuttered CW laser or an electronically controlled CW laser such as a diode laser, so that the CW excitation of the cavity may be cut off to allow measurement of a ring-down decay curve.

In general, overlap with either transverse or longitudinal modes will allow the cavity to fill with light. The light source may be configured to excite at least two longitudinal modes of oscillation of the (ring-down) cavity and more preferably at least five or ten modes of the cavity are simultaneously excited, to allow for the effects of vibration, temperature and the like; this allows many transverse modes to be used. In practice the number of populated transverse modes may depend on how well the cavity is optically aligned, which can vary over time.

The spectral output of the light source (power versus frequency) will generally have one or more maxima and preferably the light source provides at least half such a maximum power (at a frequency) into each of the two, five or ten (or more) modes. Where the spectral output of the light source has a shape which is appropriate to describe by reference to a full width at half maximum (FWHM) power (or intensity) output then preferably the FWHM of light source is greater than one free spectral range (FSR) of the (ring-down) cavity, and preferably greater than two FSRs of the cavity.

Employing a continuous wave light source facilitates rapid repeated measurements of the ring-down characteristics of the cavity. To improve sensitivity and reduce noise ring-down events are preferably observed at a frequency of greater than 1 kHz, more preferably at a frequency of greater than 10 kHz. This compares with a typical repetition frequency of around 10 Hz for a pulsed laser. To facilitate accurate measurement of a ring-down time the CW light source output is preferably cut off (falltime from 90% to 10% output) in less than 100 ns, more preferably in less than 50 ns. This facilitates observations of sufficient intra-cavity bounces for accurate measurement where decay times are of the order of 500 ns.

Although the skilled person will understand references to a “continuous wave laser”, some explanation of the term “continuous” is desirable in the context of an instrument in which interrupted continuous wave light is applied repeatedly to a ring-down cavity to measure a succession of decay curves for averaging. A pulsed laser has an inherently wide bandwidth, broadly speaking determined by the inverse of the pulse duration. By contrast in this specification “continuous” is used to refer to a light source which provides an output for a period which is long compared with a period associated with (inverse of), the frequency separation of adjacent (longitudinal) modes of the ring-down cavity; this is with a fourier bandwidth smaller than the frequency separation of adjacent modes. It will be appreciated that even when an (interrupted) continuous wave source is employed to obtain repeated decay curve measurements at up to, say, 1 MHz, this is still three orders of magnitude longer than typical pulsed laser output times, which are generally of the order of nanoseconds. Thus, the cavity sees a sequence of effectively continuous wave stimuli.

In another aspect the invention provides [as claim 10].

The number of passes light makes through the cavity depends upon the Q of the cavity which, broadly speaking, should be as high as possible. As the skilled person will understand the Q-factor of the cavity is related to ratio of energy stored within the cavity to a rate of energy dissipation within the cavity. Although the cavity ring-down is responsive to absorption in the cavity this absorption may either be direct absorption by a sensed material or may be a consequence of some other physical effect or measured property.

In the above described sensors and devices the cavity preferably has a length of greater than 0.5 m more preferably of greater than 1.0 m. This is because the mode spacing in frequency varies inversely with the cavity length so that a longer cavity results in closer spaced longitudinal modes, again facilitating coupling of the CW light into the cavity.

In a preferred embodiment the cavity comprises a fibre optic cable with reflective ends. In embodiments this provides a number of advantages including physical and optical robustness, physically small size, and flexibility, enabling use of such a sensor in a wide range of applications, durability, and ease of manufacture.

Broadly speaking use of a fibre optic cable to provide a ring-down cavity enables the construction of field rather than lab-based embodiments of the above described apparatus. However an unmodified fibre optic cable is unsuitable for use as an evanescent-wave sensor for a cavity ring-down device.

According to a further aspect of the invention there is therefore provided [as claim 18].

The invention also provides [as claim 19].

Embodiments of a sensor of this form are suitable for use in a wide variety of, in some cases hostile, environments. By reducing the thickness of the cladding, in embodiments to expose the core, the evanescent wave can interact with a sensed material or substance, for example in a liquid which the fibre optic sensor is immersed. The cladding may be reduced in thickness over part or all of the circumference of the fibre, depending upon the application, desired robustness and alike.

One, or preferably both ends of the fibre optic cable may be provided with a highly reflecting surface such as a Bragg stack. The fibre optic cable thus provides a stable cavity, that is guided light confined within the cable will retrace its path many times. Preferably the fibre optic cable (and hence cavity) has a length of at least a length of 0.5 m, and more preferably of at least 1.0 m, to facilitate coupling of a continuous wave laser to the fibre optic sensor, as described above. The sensor may be coupled to a fibre optic extension and, optionally, may include an optical fibre amplifier; such an amplifier may be incorporated within the cavity.

The fibre optic cable is preferably a step index fibre, although a graded index fibre may also be used, and may comprise a single mode or polarization-maintaining or high birefringence fibre. Preferably the sensing portion of the cable has a loss of less than 1%, more preferably less than 0.5%, most preferably less than 0.25%, so that the cavity has a relatively high Q and consequently a high sensitivity. Where the sensor is to be used in a liquid the core of the fibre should have a greater refractive index than that of the liquid in which it is to be immersed in order to restrict losses from the cavity.

In one embodiment the sensor is attached to a Y-coupling device to facilitate single-ended use of the sensor, for example inside a human or animal body. The sensor may advantageously be incorporated into an evanescent-wave cavity-based sensing device such as has been previously described.

The skilled person will understand that features and aspects of the above described sensors and apparatus may be combined.

In a further aspect the invention provides [as claim 17].

The invention also provides [as claim 32].

In all the above aspects of the invention references to optical components and to light includes components for and light of non-visible wavelengths such as infrared and other light.

These and other aspects of the present invention will now be further described, by way of example only, with reference to the accompanying figures:

FIGS. 1a-1f show, respectively, an operating principle of a CRDS-type system, an operating principle of an e-CRDS-type system, a block diagram of a continuous wave e-CRDS system, and first, second and third total internal reflection devices for a CW e-CRDS system;

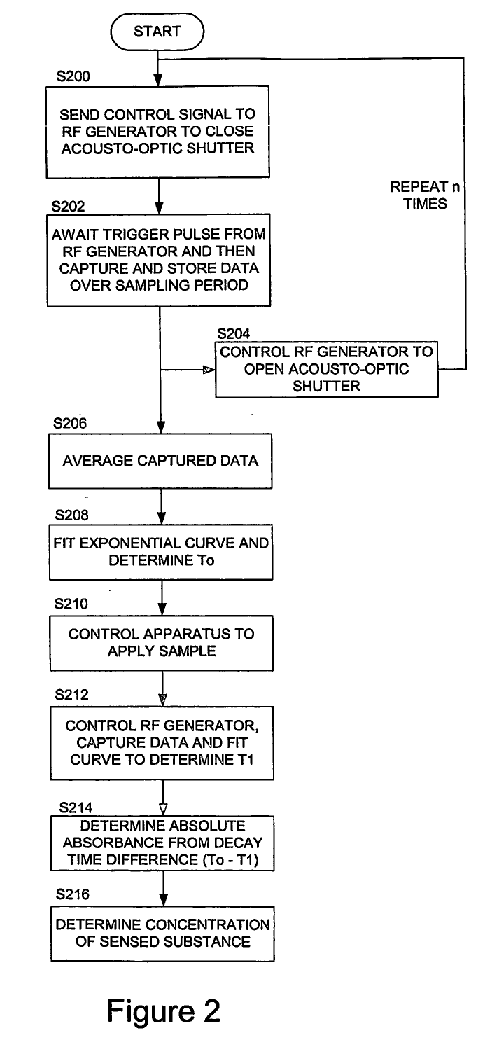

FIG. 2 shows a flow diagram illustrating operation of the system of FIG. 1c;

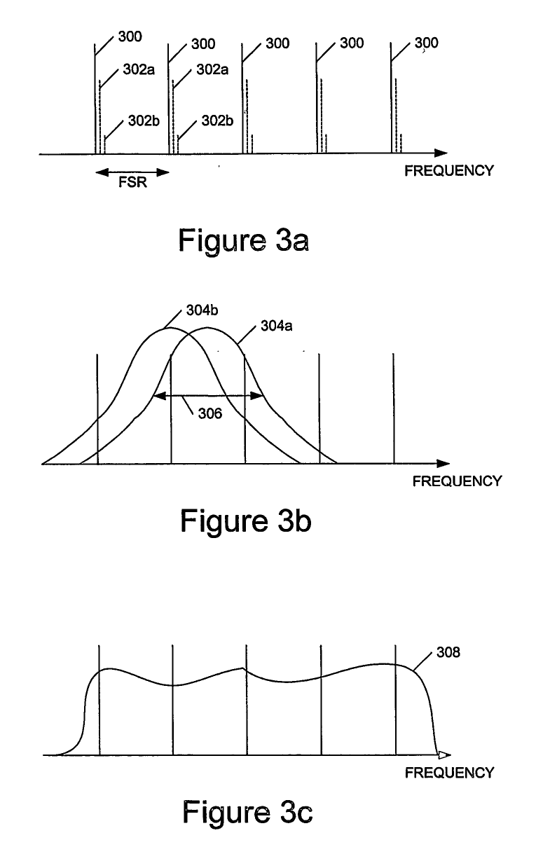

FIGS. 3a-3c show, respectively, cavity oscillation modes for the system of FIG. 1c, a first spectrum of a CW laser for use with the system of FIG. 1c, and a second CW laser spectrum for use with the system of FIG. 1c;

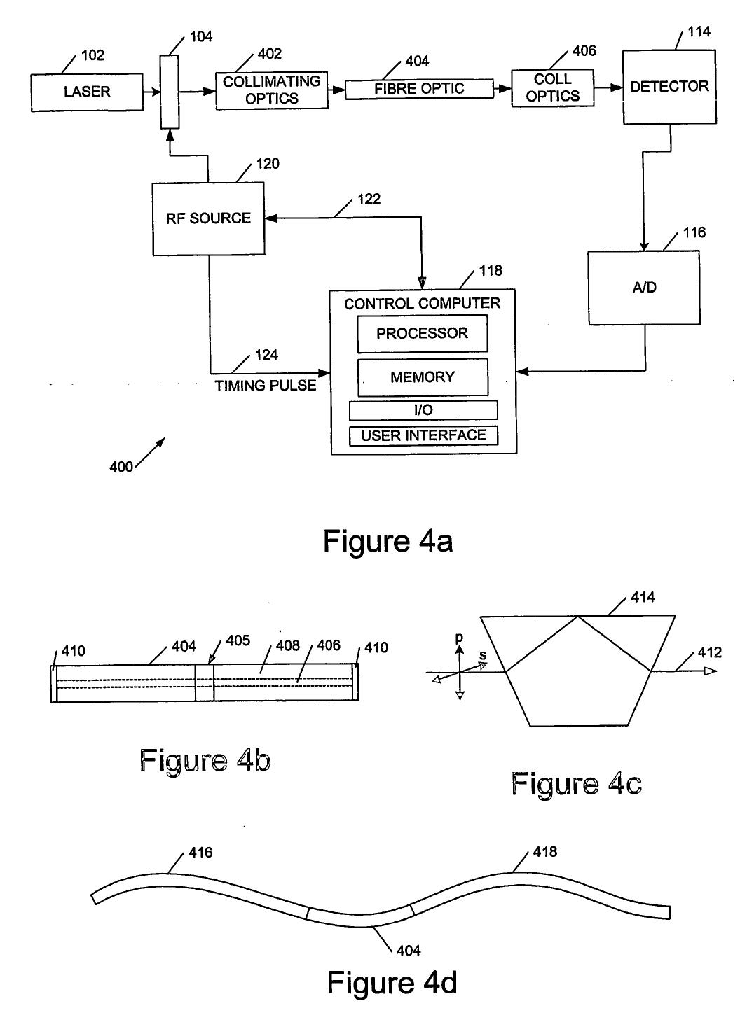

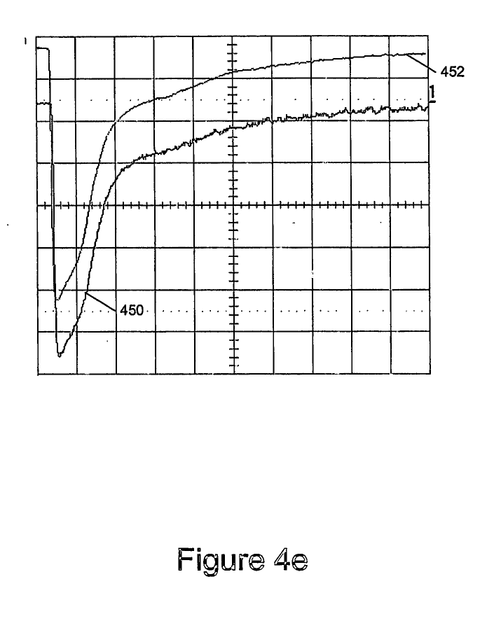

FIGS. 4a-4e show, respectively, a fibre optic-based e-CRDS system, a fibre optic cable for the system of FIG. 4a, an illustration of the effect of polarization in a total internal reflection device, a fibre optic cavity-based sensor, and fibre optic cavity ring-down profiles;

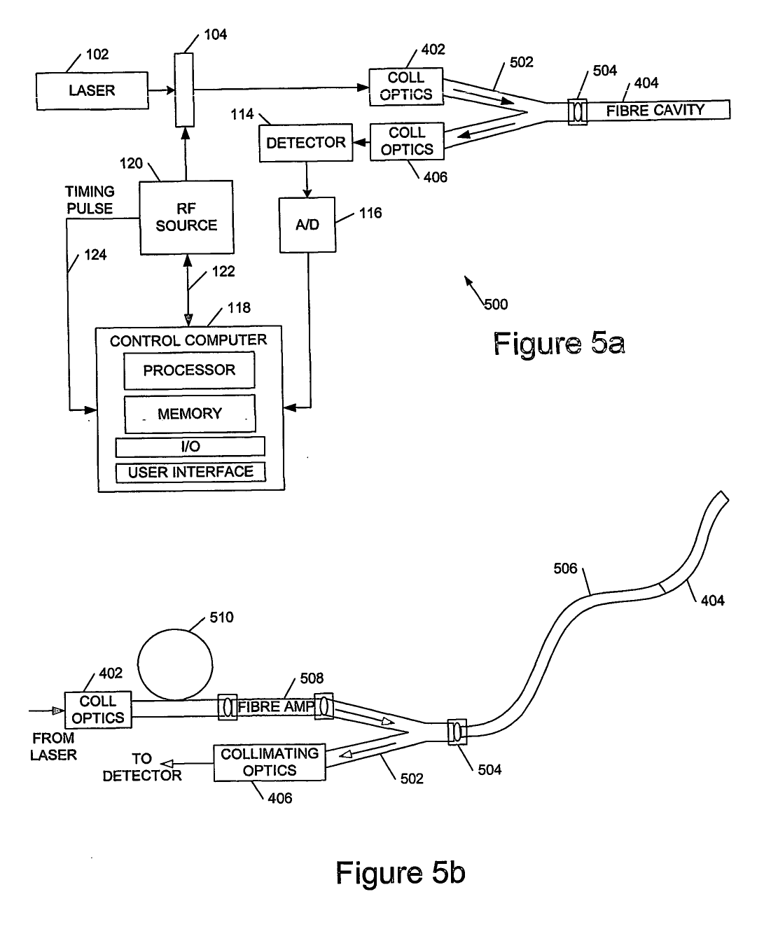

FIGS. 5a and 5b show, respectively, a second fibre optic based e-CRDS device, and a variant of this device;

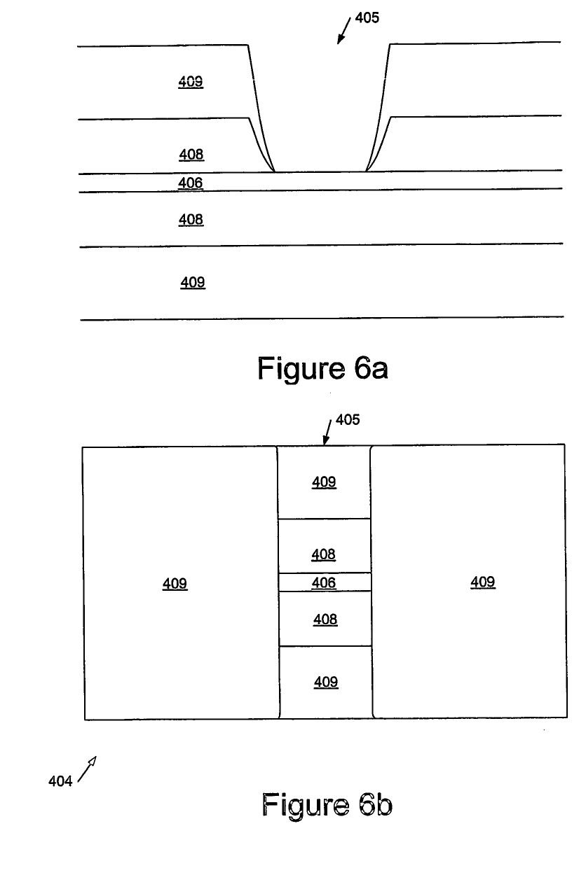

FIGS. 6a and 6b show, respectively, a cross sectional view and a view from above of a sensor portion of a fibre optic cavity;

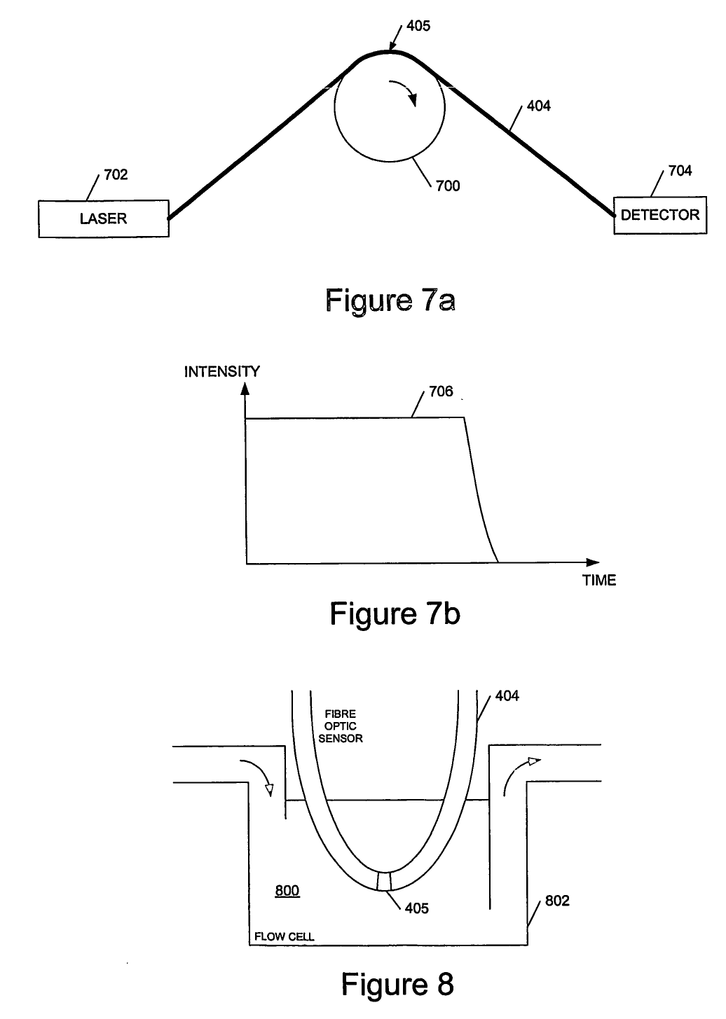

FIGS. 7a and 7b show, respectively, a procedure for forming the sensor portion of FIG. 6, and a detected light intensity-time graph associated with the procedure of FIG. 7a; and

FIG. 8 shows an example of an application of an e-CRDS-based fibre optic sensor.

Referring now to FIG. 1c, this shows an example of an e-CRDS-based system 100, in which light is injected into the cavity using a continuous wave (CW) laser 102. In the apparatus 100 of FIG. 1c the ring-down cavity comprises high reflectivity mirrors 108, 110 and includes a total internal reflection device 112. Mirrors 108 and 110 may be purchased from Layertec, Ernst-Abbe-Weg 1, D-99441, Mellingen, Germany. In practice the tunability of the system may be determined by the wavelength range over which the mirrors provide an adequately high reflectivity. Light is provided to the cavity by laser 102 through the rear of mirror 108 via an acousto-optic (AO) modulator 104 to control the injection of light. In one embodiment the output of laser 102 is coupled into an optical fibre and then focused onto a AO modulator 104 with 100 micron spot, the output from AOM 104 then can be collected by a further fibre optic before being introduced into the cavity resonator. This arrangement facilitates chop times of the order of 50 ns, such fast chop times being desirable because of the relatively low finesse of the cavity resonator.

Laser 102 may comprise, for example, a CW ring dye laser operating at a wavelength of approximately 630 nm or some other CW light source, such as a light emitting diode may be employed. For reasons which will be explained further below, the bandwidth of laser (or other light source) 102 should be greater than one free spectral range of the cavity formed by mirrors 108,110 and in one dye laser-based embodiment laser 102 has a bandwidth of approximately 5 GHz. A suitable dye laser is the Coherent 899-01 ring-dye laser, available from Coherent Inc, California, USA. Use of a laser with a large bandwidth excites a plurality of modes of oscillation of the ring-down cavity and thus enables the cavity be “free running”, that is the laser cavity and the ring-down cavity need not rely on positional feedback to control cavity length to lock modes of the two cavities together. The sensitivity of the apparatus scales with the square root of the chopping rate and employing a continuous wave laser with a bandwidth sufficient to overlap multiple cavity modes facilitates a rapid chop rate, potentially at greater than 100 KHz or even greater than 1 MHz.

A radio frequency source 120 drives AO modulator 104 to allow the CW optical drive to cavity 108, 110 to be abruptly switched off (in effect the AO modulator acts as a controllable diffraction grating to steer the beam from laser 102 into or away from cavity 108, 100). A typical cavity ring-down time is of the order of a few hundred nanoseconds and therefore, in order to detect light from a significant number of bounces in the cavity, the CW laser light should be switched off in less than 100 ns, and preferably in less than about 30 ns. Data collected during this initial 100 ns period, that is data from an initial portion of the ring-down before the laser has completely stopped injecting light into the cavity, is generally discarded. To achieve such a fast switch-off time with the above mentioned dye laser an AO modulator such as the LM250 from Isle Optics, UK, may be used in conjunction with a RF generator such as the MD250 from the same company.

The RF source 120 and, indirectly, the AO modulator 104, is controlled by a control computer 118 via an IBEE bus 122. The RF source 120 also provides a timing pulse output 124 to the control computer to indicate when light from laser 102 is cut off from the cavity 108-110. It will be recognized that the timing edge of the timing pulse should have a rise or fall time comparable with or preferably faster than optical injection shut-off time.

Use of a tunable light source such as a dye laser has advantages for some applications but in other applications a less tunable CW light source, such as a solid state diode laser may be employed, again in embodiments operating at approximately 630 nm. It has been found that a diode laser may be switched off in around 10 ns by controlling the electrical supply to the laser, thus providing a simpler and cheaper alternative to a dye laser for many applications. In such an embodiment RF source 120 is replaced by a diode laser driver which drives laser 102 directly, and AO modulator 104 may be dispensed with. An example of a suitable diode laser is the PPMT LD1338-F2, from Laser 2000 Ltd, UK, which includes a suitable driver, and a chop rate for the apparatus, and in particular for this laser, may be provided by a Techstar FG202 (2 MHz) frequency generator.

A small amount of light from the ring-down cavity escapes through the rear of mirror 110 and is monitored by a detector 114, in a preferred embodiment comprises a photo -multiplier tube (PMT) in combination with a suitable driver, optionally followed by a fast amplifier. Suitable devices are the H7732 photosensor module from Hammatsu with a standard power supply of 15V and an (optional) Ortec 9326 fast pre-amplifier. Detector 114 preferably has a rise time response of less than 100 ns more preferably less than 50 ns, most preferably less than 10 ns. Detector 114 drives a fast analogue-to-digital converter 116 which digitizes the output signal from detector 114 and provides a digital output to the control computer 118; in one embodiment an A to D on board a LeCroy waverunner LT 262 350 MHz digital oscilloscope was employed. Control computer 118 may comprise a conventional general purpose computer such as a personal computer with an IBEE bus for communication with the scope or A/D 116 may comprise a card within this computer. Computer 118 also includes input/output circuitry for bus 122 and timing line 124 as well as, in a conventional manner, a processor, memory, non-volatile storage, and a screen and keyboard user interface. The non-volatile storage may comprise a hard or floppy disk or CD-ROM, or programmed memory such as ROM, storing program code as descnbed below. The code may comprise configuration code for LabView (Trade Mark), from National Instruments Corp, USA, or code written in a programming language such as C.

Examples of total internal reflection devices which may be employed for device 112 of FIG. 1c are shown in FIGS. 1d, 1e and 1f. FIG. 1d shows a fibre optic cable-based sensing device, as described in more detail later. FIG. 1e shows a first, Pellin Broca type prism, and FIG. 1f shows a second prism geometry. Prisms of a range of geometries, including Dove prisms, may be employed in the apparatus of FIG. 1c, particularly where an anti-reflection coating has been applied to the prism. The prisms of FIGS. 1e and 1f may be formed from a range of materials including, but not limited to glass, quartz, mica, calcium fluoride, fused silica, and borosilicate glass such as BK7.

Referring now to FIG. 2, this shows a flow diagram of one example of computer program code operating on control computer 118 to control the apparatus of FIG. 1c.

At step S200 control computer 118 sends a control signal to RF source 120 over bus 122 to control radio frequency source 120 to close AO shutter 104 to cut off the excitation of cavity 108-110. Then at step S202, the computer waits for a timing pulse on line 124 to accurately define the moment of cut-off, and once the timing pulse is received digitized light level readings from detector 114 are captured and stored in memory. Data may be captured at rates up to, for example, 1 G samples per second (1 sample/ns at either 8 or 16 bit resolution) preferably over a period of at least five decay lifetimes, for example, over a period of approximately 5 μs. Computer 118 then controls RF generator to re-open the shutter and the procedure loops back to step S200 to repeat the measurement, thereby capturing a set of cavity ring-down decay curves in memory.

When a continuous wave laser source is used to excite the cavity decay curves may be captured at a relatively high repetition rate. For example, in one embodiment decay curves were captured at a rate of approximately 20 kHz per curve, and in theory it should be possible to capture curves virtually back-to-back making measurements substantially continuously (with a small allowance for cavity ring-up time). Thus, for example, when capturing data over a period of approximately 5 μs it should be possible to repeat measurements at a rate of approximately 20 kHz. The data from the captured decay curves are then averaged at step S206, although in other embodiments other averaging techniques, such as a running average, may be employed.

At step S208 the procedure fits an exponential curve to the averaged captured data and uses this to determine a decay time τ₀ for the cavity in an initial condition, for example when no material to be sensed is present. The decay time τ₀ is the time taken for the light intensity to fall to 1/e of its initial value (e=2.718). Any conventional curve fitting method may be employed; one straight-forward method is to take a natural logarithm of the light intensity data and then to employ a least squares straight line fit. Preferably data at the start and end of the decay curve is omitted when determining the decay time, to reduce inaccuracies arising from the finite switch-off time of the laser and from measurement noise. Thus for example data between 20 percent and 80 percent of an initial maximum may be employed in the curve fitting. Optionally a baseline correction to the captured light intensity may be applied prior to fitting the curve; this correction may be obtained from an initial calibration measurement.

Following this initial decay time measurement computer 118 controls the apparatus to apply a sample (gas, liquid or solid) to the total internal reflection device 112 within the ring-down cavity; alternatively the sample may be applied manually. The procedure then, at step S212, effectively repeats steps S200-S208 for the cavity including the sample, capturing and averaging data for a plurality of ring-down curves and using this averaged data to determine a sample cavity ring-down decay time τ₁. Then, at step S214, the procedure determines an absolute absorption value for the sample using the difference in decay times (τ₀−τ₁) and, at step S216, the concentration of the sensed substance or species can be determined. This is described further below.

In an evanescent wave ring-down system such as that shown in FIG. 1c the total (absolute) absorbance can be determined from Δτ=τ₁−τ₀ using equation 2 below.

$$Abs = \frac{Δ t}{{ττ}_{0}} ( \frac{{t}_{r}}{2} ) \qquad ( Equation 2 )$$

In equation 2 tᵣ is the round trip time for the cavity, which can be determined from the speed of light and from the optical path length including the total internal reflection device. The molecular concentration can then be determined using equation 3;
Absorbance=ε C L (Equation 3)
where ε is the (molecular) extinction co-efficient for the sensed species, C is the concentration of the species in molecules per unit volume and L is the relevant path length, that is the penetration depth of the evanescent wave into the sensed medium, generally of the order of a wavelength. Since the evanescent wave decays away from the total internal reflection interface strictly speaking equation 3 should employ the Laplace transform of the concentration profile with distance from the TIR surface, although in practice physical interface effects may also come into play. A known molecular extinction co-efficient may be employed or, alternatively, a value for an extinction co-efficient for equation 3 may be determined by characterizing a material beforehand.

Referring next to FIG. 3a this shows a graph of frequencies (or equivalently, wavenumber) on the horizontal axis against transmission into a high Q cavity such as cavity 108, 110 of FIG. 1c, on the vertical axis. It can be seen that, broadly speaking, light can only be coupled into the cavity at discrete, equally-spaced frequencies corresponding to allowed longitudinal standing waves within the cavity known as longitudinal cavity modes. The interval between these modes is known as the free spectral range (FSR) of the cavity and is defmed as equation 4 below.
FSR=(l/2c′) (Equation 4)

Where l is the length of the cavity and c′ is the effective speed of light within the cavity, that is the speed of light taking into account the effects of a non-unity refractive index for materials within the cavity. For a one-meter cavity, for example, the free spectral range is approximately 150 MHz. Lines 300 in FIG. 3a illustrate successive longitudinal cavity modes. FIG. 3a also shows (not to scale) a set of additional, transverse cavity modes 302a, b associated with each longitudinal mode, although these decay rapidly away from the longitudinal modes. The transverse modes are much more closely spaced than the longitudinal modes since they are determined by the much shorter transverse cavity dimensions. To couple continuous wave radiation into the cavity descnbed by FIG. 3a the light source with sufficient bandwidth to overlap at least too longitudinal cavity modes may be employed. This is shown in FIG. 3b.

FIG. 3b shows FIG. 3a with an intensity (Watts per m²) or equivalently power spectrum 304a, b for a continuous wave laser superimposed. It can be seen that provided the full width at half maximum 306 of the laser output spans at least one FSR laser radiation should continuously fill the cavity, even if the peak of the laser output moves, as shown by spectra 304a and b. In practice the laser output may not have the regular shape illustrated in FIG. 3b and FIG. 3c illustrates, diagrammatically an example of the spectral output 308 of a dye laser which, broadly speaking, comprises a super imposition of a plurality of broad resonances at the cavity modes of the laser.

Referring again to FIG. 3b it can be seen that as the peak of the laser output moves, although two modes are always excited these are not necessarily the same two modes. It is desirable to continuously excite a cavity mode, taking into account shifts in mode position caused by vibration and/or temperature changes and it is therefore preferable that the laser output overlaps more than two modes, for example, five modes (as shown in FIG. 3c) or ten modes. In this way even if mode or laser frequency changes one mode at least is likely to be continuously excited. To cope with large temperature variations a large bandwidth may be needed and for certain designs of instruments, for example, fibre optic-based instruments it is similarly desirable to use a CW laser with a bandwidth of five, ten or more FSRs. For example a CW ring dye laser with a bandwidth of 5 GHz has advantageously employed with a cavity length of approximately one meter and hence an FSR of approximately 150 MHz.

For clarity transverse modes have not been shown in FIG. 3b or FIG. 3c but it will be appreciated light may be coupled into modes with a transverse component as well as a purely longitudinal modes, although to ensure continuous excitation of a cavity it is desirable to overlap at least two different longitudinal modes of the cavity

In order to excite a cavity mode sufficient power must be coupled into the cavity to overcome losses in the cavity so that the mode, in effect rings up. Preferably, however, at least half the maximum laser intensity at its peak frequency is delivered into at least two modes since this facilitates fast repetition of decay curve measurement and also increases sensitivity since decay curves will begin from a higher initial detected intensity. It will be appreciated that when the bandwidth of the CW laser overlaps with longitudinal modes of the ring-down cavity as described above, the power within the cavity depends on the incident power of the exciting laser, which enables the power within the cavity to be controlled, thus facilitating power dependent measurements and sensing.

FIG. 4a shows a fibre optic-based e-CRDS type sensing system 400 similar to that shown in FIG. 1c, in which like elements are indicated by like reference numerals. In FIG. 4a, however, mirrors 108, 110, and total internal reflection device 112 are replaced by fibre optic cable 404, the ends of which have been treated to render them reflective to form a fibre optic cavity. In addition collimating optics 402 are employed to couple light into fibre optic cable 404 and collimating optics 406 are employed to couple light from fibre optic cable 404 into detector 414.

FIG. 4b shows further details of fibre optic cable 404, which, in a conventional manner comprises a central core 406 surrounded by cladding 408 of lower refractive index than the core. Each end of the fibre optic cable 404 is, in the illustrated embodiment polished flat and provided with a multi layer Bragg stack 410 to render it highly reflective at the wavelength of interest. As the skilled person will be aware, a Bragg stack is a stack of quarter wavelength thick layers of materials of alternating refractive indices. To deposit the Bragg stacks the ends of the fibre optic cable are first prepared by etching away the surface and then polishing the etched surface flat to within, for example, a tenth of a wavelength (this polishing criteria is a commonly adopted standard for high-precision optical surfaces). Bragg stacks may then be deposited by ion sputtering of metal oxides; such a service is offered by a range of companies including the above-mentioned Layertec, Gmbh. Fibre optic cable 404 includes a sensor portion 405, as described further below.

Preferably optical fibre 404 is a single mode step index fibre, advantageously a single mode polarization preserving fibre to facilitate polarization-dependent measurements and to facilitate enhancement of the evanescent wave field. Such enhancement can be understood with reference to FIG. 4c which shows total internal reflection of light 412 at a surface 414. It can be seen from inspection of FIG. 4c that p-polarized light (within the plane containing light 412 and the normal to surface 414) generates an evanescent wave which penetrates further from surface 414 than does s-polarized light (perpendicular to the plane containing light 412 and the normal to surface 414).

The fibre optic cable is preferably selected for operation at a wavelength or wavelengths of laser 102. Thus, for example, where laser 102 operates in the region of 630 nm so called short-wavelength fibre may be employed, such as fibre from INO at 2470 Einstein Street, Sainte-Foy, Quebec, Canada. Broadly speaking suitable fibre optic cables are available over a wide range of wavelengths from less than 500 nm to greater than 1500 nm. Preferably low loss fibre is employed. In one embodiment single mode fibre (F601A from INO) with a core diameter of 5.6 μm (a cut-off at 540 nm, numerical aperture of 0.11, and outside diameter of 125 μm)and a loss of 7 dB/km was employed at 633 nm, giving a decay time of approximately 1.5 μs with a one meter cavity and an end reflectivity of R=0.999. In general the decay time is given by equation 5 below where the symbols have their previous meanings, f is the loss in the fibre (units of m⁻¹ i.e. percentage loss per metre) and l is the length of the fibre in metres.
Δτ=tᵣ/{2(1−R)+fl} (Equation5)

FIG. 4d illustrates a simple example of an alternative configuration of the apparatus of FIG. 4a, in which fibre optic cavity 404 is incorporated between two additional lengths of fibre optic cable 416, 418, light being injected at one end of fibre optic cable 416 and recovered from fibre optic cable 418, which provides an input to detector 114. Fibre optic cables 414, 416 and 418 may be joined in any conventional manner, for example using a standard FC/PC-type connector.

FIG. 4e shows two examples of cavity ring-down decay curves obtained with apparatus similar to that shown in FIG. 4a with a cavity of length approximately one meter and the above mentioned single mode fibre. FIG. 4e shows two sampling oscilloscope traces captured at 500 mega samples per second with a horizontal (time) grid division of 0.2 μs and a vertical grid division of 50 μV. Curve 450 represents a single measurement and curve 452 and average of nine decay curve measurements (in FIG. 4e the curve has been displaced vertically for clarity) the decay time for the averaged decay curve 452 was determined to be approximately 1.7 μs. The slight departure from an exponential shape (a slight kink in the curve) during the initial approximately 100 ns is a consequence of coupling of radiation into the cladding of the fibre, which is rapidly attenuated by the fibre properties and losses to the surroundings.

Referring now to FIG. 5a this shows a variant of the apparatus of FIG. 4a, again in which like elements are indicated by like reference numerals. In FIG. 5a a single-ended connection is made to fibre cavity 404 although, as before, both ends of fibre 404 are provided with highly reflecting surfaces. Thus in FIG. 5a a conventional Y-type fibre optic coupler 502 is attached to one end of fibre cavity 404, in the illustrated example by an FC/PC screw connector 504. The Y connector 502 has one arm connected to collimating optics 402 and its second arm connecting to collimating optics 406. To allow laser light to be launched into fibre cavity 404 and light escaping from fibre cavity 404 to be detected from a single end of the cavity. This facilitates use of a fibre cavity-based sensor (such as is described in more detail below) in many applications, in particular applications where access both ends of the fibre is difficult or undesirable. Such applications include intra-venous sensing within a human or animal body and sensing within an oil well bore hole.

FIG. 5b shows a variant in which fibre cavity 404 is coupled to Y-connector 502 via an intermediate length of fibre optic cable 506 (which again may be coupled to cable 504 via a FC/PC connector). FIG. 5b also illustrates the use of an optional optical fibre amplifier 508 such as an erbium-doped fibre amplifier. In the illustrated example fibre amplifier 508 is acting as a relay amplifier to boost the output of collimating optics 402 after a long run through a fibre optic cable loop 510. (For clarity in FIG. 5b the pump laser for fibre amplifier 508 is not shown). The skilled person will appreciate that many other configurations are possible. For example provided that the fibre amplifier is relatively linear it may be inserted between Y coupler 502 and collimating optics 506 without great distortion of the decay curve. Generally speaking, however, it is preferable that detector 114 is relatively physically close to the output arm of Y coupler 512, that is preferably no more than a few centimeters from the output of this coupler to reduce losses where practically possible; alternatively a fibre amplifier may be incorporated within cavity 404. In further variants of the arrangement of figures multiple fibre optic sensors may be employed, for example by splitting the shuttered output of laser 102 and capturing data from a plurality of detectors, one for each sensor. Alternatively laser 102, shutter 104, and detector 114 may be multiplexed between a plurality of sensors in a rotation.

To utilize the fibre optic cavity 404 as a sensor of an e-CRDS based instrument access to an evanescent wave guided within the fibre is needed. FIGS. 6a and 6b show one way in which such access may be provided. Broadly speaking a portion of cladding is removed from a short length of the fibre to expose the core or more particularly to allow access to the evanescent wave of light guided in the core by, for example, a substance to be sensed.

FIG. 6a shows a longitudinal cross section through a sensor portion 405 of the fibre optic cable 404 and FIG. 6b shows a view from above of a part of the length of fibre optic cable 404 again showing sensor portion 405. As previously explained the fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen from FIG. 6 at the sensor portion of the cable the cladding 408 is at least partially removed to expose the core and hence to permit access to the evanescent wave from guided light within the core. The thickness of the cladding is typically 100 μm or more, but the cladding need not be entirely removed although preferably less than 10 μm thickness cladding is left at the sensor portion of the cable. It will be appreciated that there is no specific restriction on the length of the sensor portion although it should be short enough to ensure that losses are kept well under one percent. It will be recognized that, if desired, multiple sensor portions may be provided on a single cable.

A sensor portion 405 on a fibre optic cable may be created either by mechanical removal of the casing 409 and portion of the cladding 408 or by chemical etching. FIGS. 7a and 7b demonstrate a mechanical removal process in which the fibre optic cable is passed over a rotating grinding wheel (with a relatively fine grain) which, over a period of some minutes, mechanically removes the casing 409 and cladding 408. The point at which the core 406 is optically exposed may be monitored using a laser 702 injecting light into the cable which is guided to a detector 704 where the received intensity is monitored. Refractive index matching fluid (not shown in FIG. 7a) is provided at the contact point between grinding wheel 700 and table 404, this fluid having a higher refractive index than the core 406 so that when the core is exposed light is coupled out of the core and the detected intensity falls to zero.

FIG. 7b shows a graph of light intensity received by detector 704 against time, showing a rapid fall in received intensity at point 706 as the core begins to be optically exposed so that energy from the evanescent wave can couple into the index matching fluid and hence out of the table. With a chemical etching process a similar procedure may be employed to check when the evanescent wave is accessible, that is when the core is being exposed, by removing the fibre from the chemical etch ant at intervals and checking light propagation through the fibre when index matching fluid is applied at the sensor portion of the fibre. An example of a suitable enchant is hydrofluoric acid (HF).

FIG. 8 shows a simple example of an application of the apparatus of FIG. 4a. Fibre optic cable 404 and sensor 405 are immersed in a flow cell 802 through which is passed an aqueous solution containing a cbromophore whose absorbance is responsive to a property to be measured such as pH. Using the apparatus of FIG. 4a at a wavelength corresponding to an absorption band of the chromophore very small changes, in this example pH, may be measured.

The above described instruments may be used for gas, liquid and solid phase measurements although they are particularly suitable for liquid and solid phase materials. Instruments of the type described, particularly those of the type shown in FIG. 1c may operate at any of a wide range of wavelengths or at multiple wavelengths. For example optical high reflectivity are mirrors available over the range 200 nm-20 μm and suitable light sources include Ti:sapphire lasers for the region 600 nm-1000 nm and, at the extremes of the frequency range, synchrotron sources. Instruments of the type shown in FIG. 4a may also operate at any of a wide range of wavelengths provided that suitable fibre optic cable is available.

No doubt many effective variants will occur to the skilled person and it will be understood that the invention is not limited to the described embodiments but encompasses modifications apparent to those skilled in the art found within the spirit and scope of the appended claims.

1-32. (canceled)

33. A cavity ring-down sensor comprising:
a ring-down optical cavity for sensing a substance modifying a ring-down characteristic of the cavity;
a continuous wave light source for exciting said cavity; and
a detector for monitoring said ring-down characteristic; and
wherein said light source has a power and bandwidth sufficient to couple energy into at least two modes of oscillation of said cavity to overcome losses within the cavity and excite said two modes of oscillation.

34. A sensor as claimed in claim 33 wherein said cavity includes an attenuated total-internal-reflection based sensing device.

35. An evanescent wave cavity-based optical sensor, the sensor comprising:
an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function;
a light source to inject light into said cavity; and
a detector to detect a light level within said cavity;
whereby absorption of said evanescent wave is detectable using said detector to provide said sensing function;
wherein said light source comprises a continuous wave light source; and
wherein said light source has a power and bandwidth sufficient to couple energy into at least two modes of oscillation of said cavity to overcome losses within the cavity and excite said two modes of oscillation.

36. A sensor as claimed in claim 35 wherein said modes comprise two different longitudinal modes of oscillation of said cavity.

37. A sensor as claimed in claim 35 wherein said light source has sufficient bandwidth to provide at least half a maximum power at frequency into each of said modes.

38. A sensor as claimed in claim 35 wherein said light source has sufficient bandwidth and power to excite at least five modes of said cavity simultaneously.

39. A sensor as claimed in claim 35 wherein said continuous wave light source comprises a continuous wave laser.

40. A sensor as claimed in claim 35 wherein said light source comprises a laser light source with a full width at half maximum (FWHM) bandwidth greater than a free spectral range of said cavity.

41. A sensor as claimed in claim 35 further comprising means to repeatedly apply said light source to said cavity, and to monitor said ring-down characteristic of said cavity at a repetition frequency of greater than 1 kHz.

42. A sensor as claimed in claim 35 wherein said cavity has a length of at least 1 m.

43. A sensor as claimed in claim 35 wherein said cavity comprises a fibre optic cable with reflective ends.

44. An optical cavity-based sensing device comprising:
an optical cavity absorption sensor comprising an optical cavity formed by a pair of reflecting surfaces;
a light source for providing light to couple into said cavity; and
a light detector for detecting a level of light escaping from said cavity;
said cavity being configured such that light within said cavity makes at least ten absorption sensing passes through said cavity before decaying to a half intensity value; and wherein
said light source is operable as a substantially continuous source and has a bandwidth sufficient to provide at least a half maximum power output across a range of frequencies equal to a free spectral range of said cavity.

45. An optical cavity-based sensing device as claimed in claim 44 wherein said optical cavity absorption sensor further comprises an evanescent wave-based sensing device.

46. An optical cavity-based sensing device as claimed in claim 44 wherein said light source has a bandwidth sufficient to provide at least a half maximum power output across a range of frequencies equal to a plurality of free spectral ranges of said cavity.

47. An optical cavity-based sensing device as claimed in claim 44 wherein said light source comprises a continuous wave laser.

48. An optical cavity-based sensing device as claimed in claim 44 further comprising means to repeatedly apply and then cut off light from said light source into said cavity at a repetition frequency of greater than 1 kHz, means to capture cavity ring-down data from said detector for said repeated applications, and means to average the results of said repeated capturing.

49. A device as claimed in claim 44 wherein said cavity has a length of at least 1 m.

50. A device as claimed in claim 44 wherein said cavity comprises a fibre optic cable with reflective ends.

51. A method of coupling light from a continuous wave light source into a cavity ring-down sensor comprising a ring-down optical cavity for sensing a substance modifying a ring-down characteristic of the cavity, the method comprising outputting light from the light source with sufficient power over sufficient bandwidth to couple energy into at least two modes of oscillation of said cavity to overcome losses within the cavity and excite said two modes of oscillation.

52. A cavity ring-down sensor comprising:
a ring-down optical cavity for sensing a substance modifying a ring-down characteristic of the cavity;
a light source for exciting said cavity; and
a detector for monitoring said ring-down characteristic; and
wherein said cavity comprises a fibre optic sensor including a fibre optic cable configured to provide access to an evanescent field of light guided within the cable for said sensing.

53. A sensor as claimed in claim 52 wherein at least one end of said fibre optic cable is configured to provide a highly reflecting surface to guided light within said cable.

54. A sensor as claimed in claim 53 wherein both ends of said fibre optic cable are configured to provide highly reflecting surfaces to guided light within said cable.

55. A sensor as claimed in claim 54 coupled to a fibre optic extension.

56. A sensor as claimed in claim 52 wherein said fibre optic cable has a length of at least 1 m.

57. A sensor as claimed in claim 52 further comprising an optical fibre amplifier.

58. A fibre optic sensor as claimed in claim 52 wherein said core is exposed at said sensing portion of said fibre optic cable.

59. A sensor as claimed in claim 52 wherein said sensing portion of said cable has an optical loss of less than 0.5%.

60. A sensor as claimed in claim 52 wherein said fibre optic cable comprises single mode cable.

61. A sensor as claimed in claim 52 wherein said fibre optic cable comprises polarisation-maintaining cable.

62. A sensor as claimed in claim 52 further comprising a coupling device, said coupling device being configured to permit both light to be launched into said fibre optic cable and detection of a light level within said cable, from a single end of said cable.

63. A sensor for a cavity of an evanescent-wave cavity ring down device, the sensor comprising a fibre optic cable having a core configured to guide light down the fibre surrounded by an outer cladding of lower refractive index than the core, wherein a sensing portion of the fibre optic cable is configured to have a reduced thickness cladding such that an evanescent wave from said guided light is accessible for sensing at said sensing portion of the cable.

64. A sensor as claimed in claim 63 wherein said fibre optic cable comprises single mode cable.

65. A sensor as claimed in claim 63 wherein said fibre optic cable comprises polarisation-maintaining cable.

66. An evanescent-wave cavity ring down device incorporating the sensor of claim 63.

67. An optical cavity based sensing device incorporating the sensor of claim 63.

68. A method of forming a fibre optic sensor for a cavity of an evanescent-wave cavity ring down device, the sensor comprising a fibre optic cable having a core configured to guide light down the fibre surrounded by an outer cladding of lower refractive index than the core, the method comprising sculpting the fibre optic cable to reduce the thickness of said cladding such that an evanescent wave from said guided light is accessible for sensing at said sensing portion of the cable.
